(19) United States
(12) Patent Application Publication
(10) Pub. No.: US 2026/0281071 A1
(43) Pub. Date: Sep. 17, 2026

(54) METHOD, APPARATUS, DEVICE, MEDIUM AND PRODUCT FOR PROCESSING MESSAGES

(71) Applicant: Beijing Zitiao Network Technology Co., Ltd., Beijing (CN)

(72) Inventors: Yuyang HAN, Beijing (CN); Gelin WU, Beijing (CN)

(21) Appl. No.: 19/563,791

(22) Filed: Mar. 11, 2026

(30) Foreign Application Priority Data
Mar. 11, 2025 (CN) 202510286447.8

(51) Int. Cl. H04L 51/216

(52) U.S. Cl. CPC H04L 51/216

(57) ABSTRACT

Embodiments of the present disclosure relate to a method, an apparatus, a device, a medium, and a product for processing messages. The method includes fetching, from a message queue, a plurality of messages to be processed sequentially. The method further includes comparing, in response to a target message among the plurality of messages having been processed, an accumulated duration for processing the plurality of messages with a threshold duration. The method further includes determining, in response to the accumulated duration exceeding the threshold duration, whether a group of unprocessed messages exists in the plurality of messages. The method further includes returning, in response to the existence of the group of unprocessed messages in the plurality of messages, the group of unprocessed messages to the message queue.

### CROSS-REFERENCE TO RELATED APPLICATION(S)

This application claims priority to Chinese Application No. 202510286447.8 filed on Mar. 11, 2025, the disclosure of which is incorporated herein by reference in its entity.

### FIELD

Embodiments of the present disclosure generally relate to the field of processing messages, and in particular, to a method, an apparatus, a device, a medium, and a product for processing messages.

### BACKGROUND

At present, the development of live streaming technology is getting more and more rapid. In the fields of e-commerce, education, entertainment, etc., live streaming scenarios are always indispensable. The development of live streaming platforms needs to take into account the experience of users in watching and interacting. Therefore, improving the smoothness of users' watching in live streaming scenarios has become the focus of research by many developers. Developers are committed to continuously enhancing the user's experience of watching live streaming by improving the efficiency of live streaming interaction.

With the continuous development of live streaming scenarios, in the live streaming interface. Among them, the main research method is to improve the smoothness of real-time message presentation. Generally, for users, obtaining real-time messages in a live streaming room smoothly can not only significantly improve the user experience, but also significantly enhance the overall experience of users when watching live streaming.

### SUMMARY

The Embodiments of the present disclosure provide a method, an apparatus, a device, a medium, and a product for processing messages.

According to a first aspect of the present disclosure, a method of processing messages is provided. The method includes fetching, from a message queue, a plurality of messages to be processed sequentially. The method further includes comparing, in response to a target message among the plurality of messages having been processed, an accumulated duration for processing the plurality of messages with a threshold duration. The method further includes determining, in response to the accumulated duration exceeding the threshold duration, whether a group of unprocessed messages exists in the plurality of messages. The method further includes returning, in response to the existence of the group of unprocessed messages in the plurality of messages, the group of unprocessed messages to the message queue.

According to a second aspect of the present disclosure, an apparatus for processing messages is provided. The apparatus includes a message fetching module configured to fetch, from a message queue, a plurality of messages to be processed sequentially; a threshold comparing module configured to compare, in response to a target message among the plurality of messages having been processed, an accumulated duration for processing the plurality of messages with a threshold duration; an unprocessed message determining module configured to determine, in response to the accumulated duration exceeding the threshold duration, whether a group of unprocessed messages exists in the plurality of messages; and an unprocessed message returning module configured to return, in response to the existence of the group of unprocessed messages in the plurality of messages, the group of unprocessed messages to the message queue.

In a third aspect of the present disclosure, an electronic device is provided, including at least one processor; and a storage apparatus for storing at least one program, the at least one program, when executed by the at least one processor, causing the at least one processor to implement the method according to the first aspect of the present disclosure.

In a fourth aspect of the present disclosure, a computer-readable storage medium is provided having a computer program stored thereon, which, when executed by a processor, implements the method according to the first aspect of the present disclosure.

In a fifth aspect of the present disclosure, a computer program product is provided. The computer program product includes a computer program, which, when executed by a processor, implements the method according to the first aspect of the present disclosure.

It should be understood that the content described in this section of content is not intended to identify critical or important features of the embodiments of the present disclosure, nor is it intended to limit the scope of the present disclosure. Other features of the present disclosure will become readily comprehensible through the following description.

### BRIEF DESCRIPTION OF THE DRAWINGS

The above and other objects, features and advantages of the present disclosure will become more apparent by describing the exemplary embodiments of the present disclosure in more detail in conjunction with the drawings, in which the same reference numerals generally represent the same components in the exemplary embodiments of the present disclosure.

FIG. 1 illustrates a schematic diagram of an example environment in which the device and/or method of some embodiments of the present disclosure may be implemented;

FIG. 2 illustrates a schematic diagram of an example method for processing messages according to some embodiments of the present disclosure;

FIG. 3 illustrates a schematic diagram of an example process of a message processing flow according to some embodiments of the present disclosure;

FIG. 4 illustrates a schematic diagram of another example process of a message processing flow according to some embodiments of the present disclosure;

FIG. 5 illustrates a schematic diagram of a frame rendering and processing process after introducing a vertical synchronization (Vsync) mechanism according to some embodiments of the present disclosure;

FIG. 6 illustrates a schematic block diagram of an apparatus for processing messages according to some embodiments of the present disclosure;

FIG. 7 illustrates a schematic block diagram of an example device suitable for implementing multiple embodiments of the present disclosure.

### DETAILED DESCRIPTION OF EMBODIMENTS

It may be understood that the data involved in the technical solution (including but not limited to the data itself, acquisition or use of the data) shall comply with requirements of corresponding laws, regulations, and related provisions.

It may be understood that before the use of the technical solutions disclosed in the embodiments of the present disclosure, the user shall be informed of the type, range of use, use scenarios, etc., of personal information involved in the present disclosure in an appropriate manner and the authorization of the user shall be obtained in accordance with related laws and regulations.

For example, when an active request of the user is received, prompt information is sent to the user to clearly inform the user that the requested operation will require access to and use of the user's personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative and does not limit the implementations of the present disclosure, and other manners that satisfy the related laws and regulations may also be applied in the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein; on the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term "include/comprise" and similar terms should be understood as open-ended inclusions, that is, "include/comprise but not limited to". The term "based on" should be understood as "based at least in part on". The term "one embodiment" or "the embodiment" should be understood as "at least one embodiment". The terms "first", "second", etc. may refer to different or same objects. Other explicit and implicit definitions may also be included below.

Generally, in a live streaming service, real-time messages from services such as comments or co-streaming are first cached in a message dispatch queue of a client before being presented to a user. In order to reduce performance pressure, a message software development kit (SDK) fetches three messages from the queue every millisecond for business consumption. In this process, if the time-consuming of a single message for business consumption is greater than 16 milliseconds (greater than the refresh interval of a user interface (UI) on a main thread), a freeze will occur, affecting the user experience.

To this end, an embodiment of the present disclosure proposes a method for processing messages. In this method, a computing device may first fetch multiple messages from a message queue. Then, after processing a target message among the multiple messages, an accumulated processing duration of the multiple messages is compared with a threshold duration. If the accumulated duration exceeds the threshold duration, the computing device may determine whether there is still a group of unprocessed messages in the multiple messages. If there is a group of unprocessed messages in the multiple messages, the computing device further puts the unprocessed messages back into the message queue to wait for the next round of processing. By means of the method, through controlling the message dispatch time, the impact on the interface refresh is reduced, the resources of the main thread are released, the inflexibility problem of the method of fetching data at a fixed time interval is also avoided, the freeze perceived by the user is reduced, and the user experience is improved.

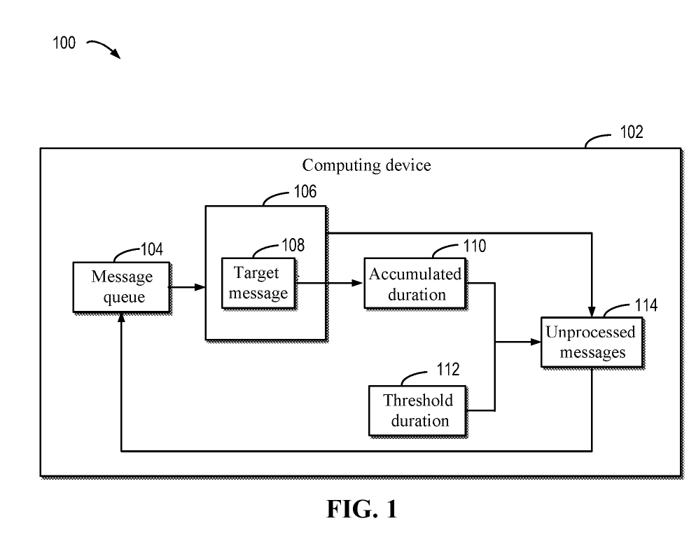

The embodiments of the present disclosure will be further described in detail below in conjunction with the drawings. FIG. 1 shows an example environment in which the device and/or method of the embodiments of the present disclosure may be implemented. In environment 100, computing device 102 may process messages under a preset condition.

Examples of computing device 102 include, but are not limited to, a personal computer, a server computer, a handheld or laptop device, a mobile device (such as a mobile phone, a personal digital assistant (PDA), a media player, etc.), a multi-processor system, a consumer electronic product, a minicomputer, a mainframe computer, a distributed computing environment including any of the above systems or devices, etc.

As shown in FIG. 1, when there is a real-time message that needs to be presented to a user, generally, the message to be processed needs to be put into a message queue to wait in line for drawing processing by a processor or a graphics processing unit of computing device 102. When computing device 102 is capable of processing messages in message queue 104, multiple messages 106 that may be processed sequentially will be fetched from message queue 104. For example, in a live streaming scenario, there may be many messages that need to be processed, so these messages may be placed in a message queue first and wait to be processed when being presented. Additionally, the multiple messages refer to three messages. The messages may be information that comes from services such as comments/co-streaming and needs to be presented to the user, which may first be cached in a message dispatch queue of computing device 102.

In one example, the messages to be processed in the message queue may be messages that are put into the message queue in real-time, or may be messages that are put back into the queue after the dispatch ends.

Then, after computing device 102 fetches multiple messages 106 that need to be processed, the messages in the multiple messages need to be processed in sequence. When multiple messages are fetched from the message queue, a processing operation on the multiple messages may be timed, and an accumulated processing duration 110 is recorded. Then, after a message is processed, the accumulated duration 110 is compared with a threshold duration 112, which is a refresh time interval of a user interface. For example, if the screen of computing device 102 is refreshed 60 times per second, the refresh time interval is 16.6 milliseconds each time. In this case, the threshold duration is 16.6 milliseconds. For other refresh frequencies, the threshold duration corresponds to the refresh time interval corresponding to the refresh frequency. Additionally, for the present disclosure, a processed message in the multiple messages may be referred to as a target message.

By comparing the accumulated duration 110 for processing on the multiple messages with the threshold duration 112, it may be determined whether the processing of the multiple fetched messages exceeds the refresh time interval. If the accumulated duration 110 exceeds the threshold duration 112, it indicates that the processing of frame information to be presented is not completed within one refresh time interval, which will cause a freeze. If there are still unprocessed messages in the multiple fetched messages, in order to avoid losing unprocessed information, computing device 102 returns the remaining unprocessed messages 114 to the message queue 104 to process them the next time the messages in the message queue are processed. Next, after waiting for a preset duration, computing device 102 re-performs message dispatching and processing in the message queue 104. For example, the preset duration may be 1 millisecond.

If the accumulated duration 110 does not exceed the threshold duration 112, computing device 102 may further determine whether there are unprocessed messages in the multiple messages. If there are still unprocessed messages in the multiple messages, it indicates that the multiple messages have not been processed completely, and computing device 102 fetches one message from the unprocessed messages and continues processing. After the message is processed, the relationship between the accumulated duration for processing the multiple messages and the threshold duration at this time continue to be determined. If there is no unprocessed message, it indicates that the fetched messages are processed within one refresh time interval, and it indicates that computing device 102 may present information normally. Then, after waiting for the threshold duration, computing device 102 may continue to fetch multiple messages to be processed from the message queue. The processing procedure of the multiple messages is the same as the procedure of processing the multiple messages described above.

By means of the method, through controlling the message dispatch time, the impact on the interface refresh is reduced, the resources of the main thread are released, the inflexibility problem of the method of fetching data at a fixed time interval is also avoided, the number of lost frames in a user's viewing process is reduced, thereby reducing the freeze perceived by the user in the application, and improving the user experience.

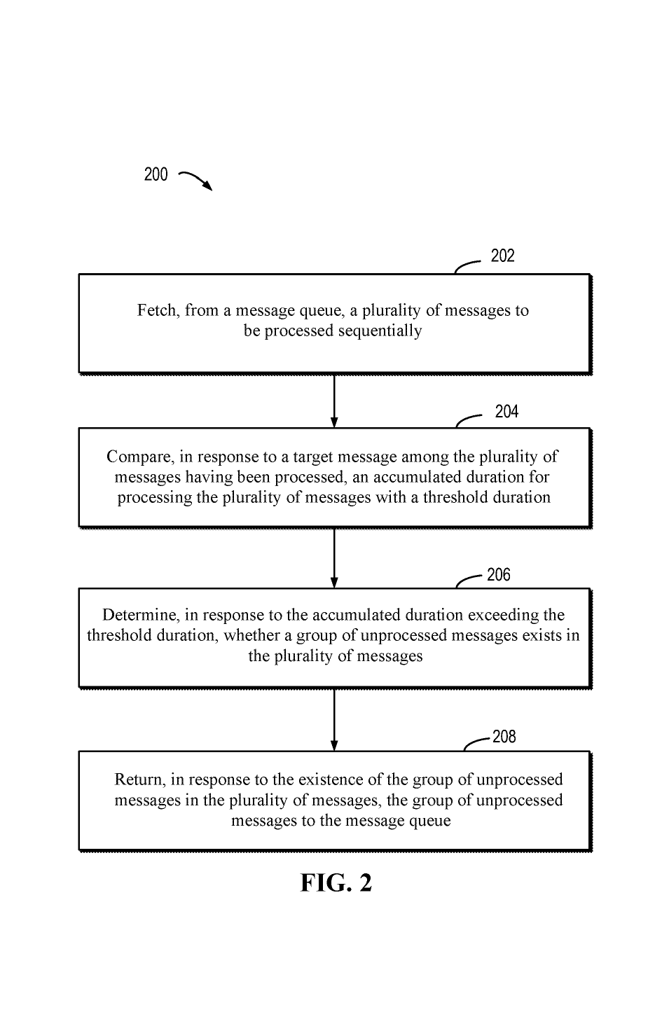

The schematic diagram of an example environment in which the device and/or method of some embodiments of the present disclosure may be implemented is described above in conjunction with FIG. 1, and the schematic diagram of an example method for processing messages according to some embodiments of the present disclosure is described below in conjunction with FIG. 2. The method in FIG. 2 may be performed by computing device 102 in FIG. 1 or any suitable computing device.

As shown in FIG. 2, in example method 200, at block 202, multiple messages 106 that may be processed sequentially are fetched by computing device 102 from message queue 104. For example, if a previous message processing task has been completed and a predetermined duration has been waited, computing device 102 may determine that the messages in message queue 104 may be processed. When computing device 102 determines that the messages in message queue 104 may be processed, multiple messages 106 are usually fetched from message queue 104.

In some embodiments, the multiple messages 106 fetched are three messages. The messages are executed in sequence, and for the convenience of description, the three messages that need to be executed in sequence are a first message, a second message, and a third message, respectively.

At block 204, in response to target message 108 among the plurality of messages 106 being processed, an accumulated duration for processing the plurality of messages is compared with a threshold duration by computing device 102. Among them, the target message is a message in the plurality of messages that has just been processed. For example, when the plurality of messages are three messages, if a first message among the three messages has been processed, the target message is the first message; and if a second message has been processed, the target message may be the second message.

Furthermore, as described above, the threshold duration is a refresh time interval for a user interface. For example, the threshold duration is 16.6 ms, and images presented to the user are generally drawn at 60 frames, so a presentation duration of 16.6 ms for one frame may be set as the preset threshold.

In some examples, after the plurality of messages 106 are fetched from the message queue 104, when the processing of the plurality of messages starts, timing also starts to record the accumulated duration 110 for processing the plurality of messages 106. After the target message is processed, the recorded accumulated duration 110 is compared with the threshold duration 112. The comparison result is used to control the execution of subsequent messages. If the accumulated duration 110 does not exceed the threshold duration 112, computing device 102 may further determine whether there is a group of unprocessed messages in the plurality of messages. If there is a group of unprocessed messages in the plurality of messages, it indicates that the plurality of messages have not been processed completely, and computing device 102 processes the group of unprocessed messages. If there is no group of unprocessed messages in the plurality of messages, it indicates that the plurality of messages have been processed completely, and computing device 102 may continue to perform subsequent message processing operations. For example, after waiting for a predetermined duration, computing device 102 continues to fetch multiple messages from the message queue for processing.

At block 206, in response to the accumulated duration 110 exceeding the threshold duration 112, whether there are unprocessed messages in the plurality of messages 106 is determined by computing device 102. Since the accumulated duration 110 has exceeded the threshold duration 112, it indicates that the processing duration of the plurality of messages has exceeded the threshold duration, which at this time will cause the processed content to be unable to be presented in time when a frame is refreshed, so that the interface still presents the previously drawn frame, resulting in a freeze of the interface.

In order to handle this situation, and speed up the presentation of a new frame and avoid message loss, computing device 102 further determines whether there are still unprocessed messages in the plurality of fetched messages. In one example, computing device 102 may determine a first number of processed messages in the plurality of messages and a second number of the plurality of messages. Then, computing device 102 compares the first number with the second number. If the first number is less than the second number of the plurality of messages, it may be determined that there is a group of unprocessed messages in the plurality of messages. If the first number is equal to the second number, it indicates that the plurality of messages have been processed completely. In another example, computing device 102 may place the plurality of messages in an array, and if a message is executed, the message is removed from the array. If there are still messages in the array, it indicates that there are unprocessed messages in the plurality of messages. If there is no message in the array, it indicates that the plurality of messages have been processed completely.

At block 208, in response to the existence of unprocessed messages 114 in the plurality of messages 106, the group of unprocessed messages 114 is returned to the message queue by computing device 102. If there are unprocessed messages 114, in order to avoid frame freezes and frame drops, at this time computing device 102 will no longer process these unprocessed messages. Instead, they are put back to the head of the message queue. The messages in the message queue are processed at the next time. Furthermore, computing device 102 displays the processed messages. Additionally, computing device 102 waits for a predetermined duration, and then continues to fetch multiple messages to be processed from the message queue. At this time, the multiple messages include the unprocessed messages returned last time.

By means of the method, the accumulated message processing duration is compared with the threshold duration to control the processing of remaining messages, thereby reducing freezes in a resource pressure scenario, providing performance improvements, and improving the user experience.

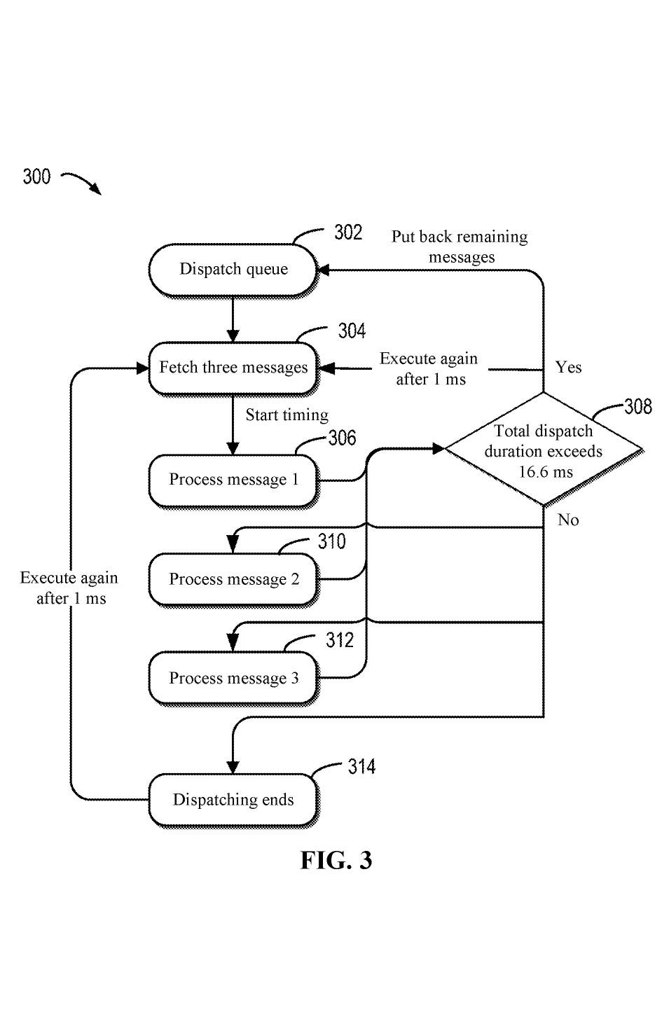

The schematic diagram of an example method for message processing according to some embodiments of the present disclosure is described above in conjunction with FIG. 2. The schematic diagram of an example process of a message processing flow according to some embodiments of the present disclosure is described below in conjunction with FIG. 3. The example process in FIG. 3 may be performed by computing device 102 shown in FIG. 1 or any suitable device.

In example 300, a schematic diagram of an example process of a message processing flow is described. Three messages are fetched from dispatch queue 302 at block 304, and at block 306, message 1 is processed and timing of an accumulated duration is started. After message 1 is processed, at block 308, whether the total dispatch duration exceeds 16.6 ms is determined. If the total dispatch duration exceeds 16.6 ms, the remaining message 2 and message 3 are put back into the dispatch queue, and after 1 ms, three message instructions continue to be fetched at block 304.

At block 308, if the total dispatch duration does not exceed 16.6 ms, message 2 continues to be processed at block 310. Similarly, after message 2 is processed, it proceeds to block 308 to determine whether the total dispatch duration at this time exceeds 16.6 ms. If the total dispatch duration exceeds 16.6 ms, message 3 is put back into the dispatch queue, and after 1 ms, three message instructions continue to be fetched at block 304.

If the total dispatch duration does not exceed 16.6 ms, message 3 continues to be processed at block 312. After message 3 is processed, it is determined at block 308 whether the total dispatch duration at this time exceeds 16.6 ms. At this time, regardless of whether the total duration exceeds 16.6 ms, three message instructions will continue to be fetched at block 304 after 1 ms.

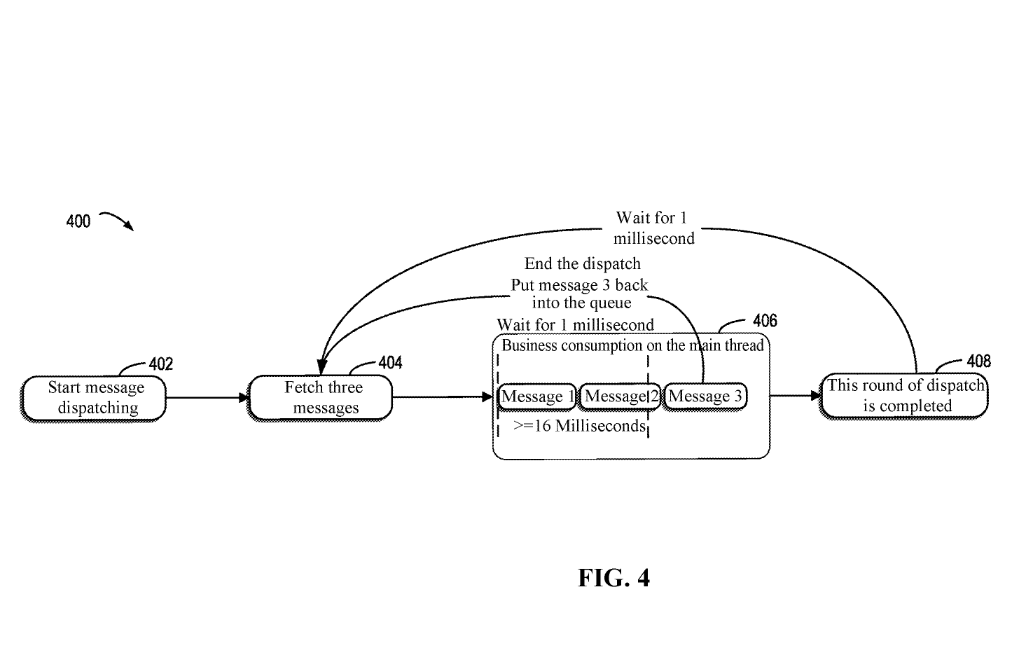

The schematic diagram of another example process of a message processing flow according to some embodiments of the present disclosure is described below in conjunction with FIG. 4. This example process may be performed by computing device 102 or any suitable device. At example 400, message dispatching starts at block 402. Then at block 404, three messages are fetched from the message queue, and at block 406, business consumption is performed on the main thread. Message 1, message 2, and message 3 are processed sequentially in sequence.

If the processing duration of message 1 and message 2 is greater than or equal to 16.6 ms, message 3 is put back into the queue, and this round of dispatching ends. If the processing duration of message 1 and message 2 is less than 16.6 ms, message 3 continues to be processed, and after the processing is completed, this round of dispatching ends at block 408. After waiting for one millisecond, three messages are fetched at block 404, and the next round of dispatching continues.

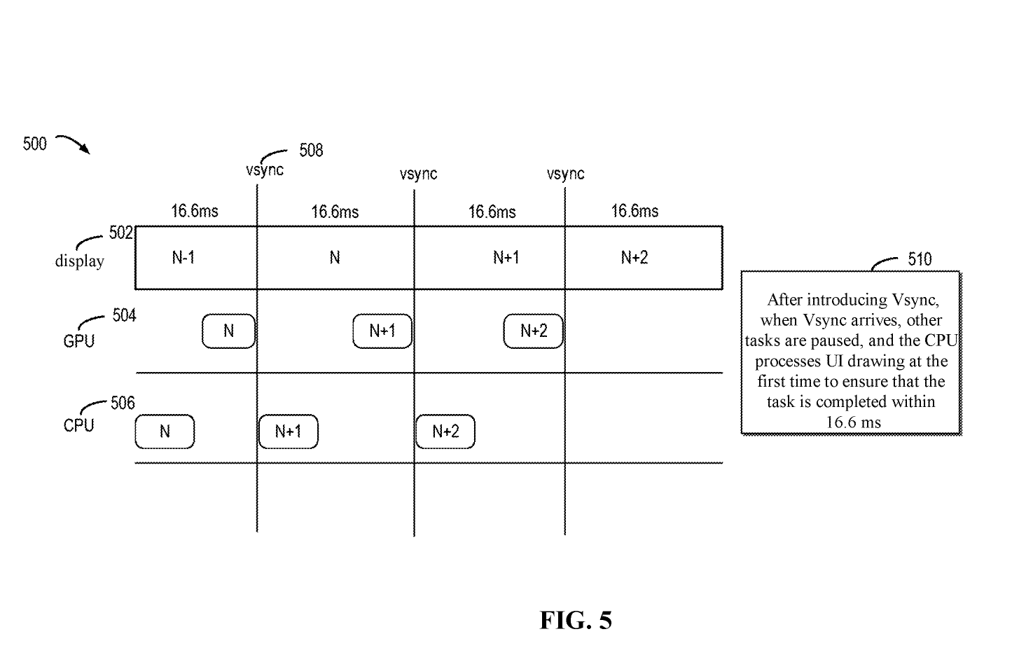

The schematic diagram of a frame rendering and processing process after introducing a vertical synchronization (Vsync) mechanism according to some embodiments of the present disclosure is described below in conjunction with FIG. 5. This procedure may be performed by computing device 102 or any suitable device. At example 500, display 502 is used to present a generated frame, GPU 504 is used to render the frame, and CPU 506 is used to render the frame. What is described in block 510 of this figure is that after Vsync is introduced, other tasks are paused when Vsync arrives, and the CPU processes UI drawing at the first time to ensure that the task is completed within 16.6 ms.

After CPU 506 finishes processing frame N, it will hand over to GPU 504 to continue rendering frame N, and at this time, display 502 displays the content of frame N-1 rendered by the CPU last time. In response to the processing duration of frame N by CPU 506 not exceeding 16.6 ms, frame N is displayed on display 502 after a vertical synchronization signal is received. If the processing duration of frame N by CPU 506 and GPU 504 exceeds 16.6 ms, frame N cannot be processed in time within one refresh time interval, and after the vertical synchronization signal is received, frame N cannot be displayed. At this time, frame N-1 is still displayed on the display.

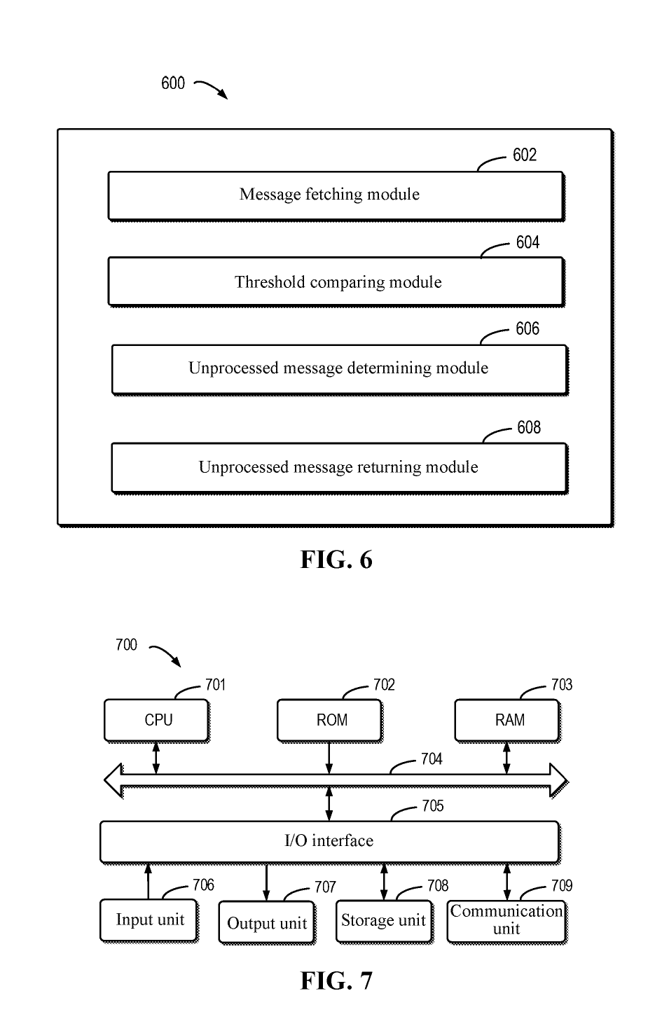

FIG. 6 illustrates a schematic block diagram of an apparatus for processing a query input according to some embodiments of the present disclosure. As shown in FIG. 6, apparatus 600 includes a candidate message fetching module 602, a threshold comparing module 604, an unprocessed message determining module 606, and an unprocessed message returning module 608. Candidate message fetching module 602 is configured to fetch, from a message queue, a plurality of messages to be processed sequentially. Threshold comparing module 604 is configured to compare, in response to a target message among the plurality of messages having been processed, an accumulated duration for processing the plurality of messages with a threshold duration. Unprocessed message determining module 606 is configured to determine, in response to the accumulated duration exceeding the threshold duration, whether a group of unprocessed messages exists in the plurality of messages. Unprocessed message returning module 608 is configured to return, in response to the existence of the group of unprocessed messages in the plurality of messages, the group of unprocessed messages to the message queue.

In some embodiments, threshold comparing module 604 includes a message timing module and a duration comparing module. The message timing module is configured to time, in response to the plurality of messages being fetched, the processing of the plurality of messages to determine the accumulated duration. The duration comparing module is configured to compare, in response to the target message among the plurality of messages having been processed, the accumulated duration with the threshold duration.

In some embodiments, unprocessed message determining module 606 includes a processed message counting module and an unprocessed message detecting module. The processed message counting module is configured to determine a first number of processed messages in the plurality of messages. The unprocessed message detecting module is configured to determine, in response to the first number being less than a second number of the plurality of messages, that the group of unprocessed messages exists in the plurality of messages.

In some embodiments, apparatus 600 further includes an unprocessed message judging module and an unprocessed message processing module. The unprocessed message judging module is configured to determine, in response to the accumulated duration not exceeding the threshold duration, whether the group of unprocessed messages exists in the plurality of messages. The unprocessed message processing module is configured to process, in response to the existence of the group of unprocessed messages in the plurality of messages, the group of unprocessed messages.

In some embodiments, apparatus 600 further includes a message processing completion judging module and a message fetching waiting module. The message processing completion judging module is configured to determine, in response to no group of unprocessed messages exists in the plurality of messages, that the plurality of messages have been processed. The message fetching waiting module is configured to wait for a predetermined duration to fetch, from the message queue, a second plurality of messages for processing.

In some embodiments, unprocessed message returning module 608 includes an unprocessed message acquiring module and an unprocessed message queue adding module. The unprocessed message acquiring module is configured to acquire a group of unprocessed messages. The unprocessed message queue adding module is configured to add the group of unprocessed messages to a head of the message queue.

In some embodiments, apparatus 600 further includes a waiting module and a third plurality of messages processing module. The waiting module is configured to wait for a predetermined duration. The third plurality of messages processing module is configured to fetch, from the message queue, a third plurality of messages for processing, the third plurality of messages including a group of unprocessed messages.

In some embodiments, the threshold duration is a refresh time interval for a user interface.

In some embodiments, the plurality of messages are three messages.

FIG. 7 shows a schematic block diagram of an example device 700 that may be used to implement the embodiments of the present disclosure. Computing device 102 in FIG. 1 may be implemented using device 700. As shown in the figure, device 700 includes a central processing unit (CPU) 701, which may perform various appropriate actions and processes based on computer program instructions stored in a read-only memory (ROM) 702 or computer program instructions loaded from a storage unit 708 into a random access memory (RAM) 703. In RAM 703, various programs and data required for the operation of device 700 may also be stored. CPU 701, ROM 702, and RAM 703 are connected to each other through a bus 704. An input/output (I/O) interface 705 is also connected to the bus 704.

Multiple components in device 700 are connected to I/O interface 705, and the components include: an input unit 706, such as a keyboard, a mouse, etc.; an output unit 707, such as various types of displays, speakers, etc.; storage unit 708, such as a magnetic disk, an optical disc, etc.; and a communication unit 709, such as a network card, a modem, a wireless communication transceiver, etc. Communication unit 709 allows device 700 to exchange information/data with other devices through a computer network such as Internet and/or various telecommunication networks.

The various procedures and processes described above, such as method 200 and process 300, may be performed by a processing unit 701. For example, in some embodiments, method 200 and process 300 may be implemented as computer software programs, which are tangibly contained in a machine-readable medium, such as storage unit 708. In some embodiments, part or entirety of the computer program may be loaded and/or installed into device 700 via ROM 702 and/or communication unit 709. When the computer program is loaded into RAM 703 and executed by CPU 701, one or more actions of the example method 200 and process 300 described above may be performed.

The present disclosure may be a method, an apparatus, a system, and/or a computer program product. The computer program product may include a computer-readable storage medium having computer-readable program instructions loaded thereon for performing various aspects of the present disclosure.

The computer-readable storage medium may be a tangible device that may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device, such as a punch card or a raised structure in a groove with instructions stored thereon, and any suitable combination of the foregoing. The computer-readable storage medium used herein is not interpreted as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from a computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages, such as Smalltalk, C++, etc., and conventional procedural programming languages, such as "C" language or similar programming languages. The computer-readable program instructions may be executed entirely on a user's computer, partly on the user's computer, as a stand-alone software package, partly on the user's computer and partly on a remote computer, or entirely on the remote computer or a server. In the case of involving the remote computer, the remote computer may be connected to the user's computer through any kind of network, including a local area network (LAN) or a wide area network (WAN), or it may be connected to an external computer (for example, connected by using Internet provided by an Internet service provider). In some embodiments, by customizing an electronic circuit, such as a programmable logic circuit, a field programmable gate array (FPGA) or a programmable logic array (PLA), using state information of the computer-readable program instructions, the electronic circuit may execute the computer-readable program instructions, thereby implementing various aspects of the present disclosure.

Various aspects of the present disclosure are described herein with reference to the flowcharts and/or block diagrams of the method, the apparatus (system), and the computer program product according to the embodiments of the present disclosure. It should be understood that each block of the flowcharts and/or block diagrams, and combinations of blocks in the flowcharts and/or block diagrams may be implemented by the computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing a function/action specified in one or more blocks of the flowcharts and/or block diagrams. These computer-readable program instructions may also be stored in a computer-readable storage medium, and these instructions make the computer, the programmable data processing apparatus, and/or other devices work in a specific manner, so that the computer-readable medium storing the instructions includes a manufactured product, which includes instructions for implementing various aspects of the function/action specified in one or more blocks of the flowcharts and/or block diagrams.

The computer-readable program instructions may also be loaded onto a computer, other programmable data processing apparatus, or other devices, so that a series of operations and steps are performed on the computer, other programmable data processing apparatus, or other devices to produce a computer-implemented process, such that the instructions executed on the computer, other programmable data processing apparatus, or other devices implement the function/action specified in one or more blocks of the flowcharts and/or block diagrams.

The flowcharts and block diagrams in the drawings show the possibly implemented architectures, functions, and operations of the system, the method, and the computer program product according to multiple embodiments of the present disclosure. In this regard, each block in the flowchart or block diagram may represent a module, program segment, or part of an instruction, which includes one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform a specified function or action, or may be implemented by a combination of special-purpose hardware and computer instructions.

The embodiments of the present disclosure have been described above, and the above description is exemplary, non-exhaustive, and not limited to the disclosed embodiments. Many modifications and variations will be apparent to those of ordinary skill in the art without departing from the scope and spirit of the described embodiments. The terminology used herein is chosen to best explain the principles of the embodiments, the practical application or technical improvement to the technology in the market, or to enable other persons of ordinary skill in the art to understand the embodiments disclosed herein.

We claim:

1. A method of processing messages, comprising:
fetching, from a message queue, a plurality of messages to be processed sequentially;
comparing, in response to a message among the plurality of messages having been processed, an accumulated duration for processing the plurality of messages with a threshold duration;
determining, in response to the accumulated duration exceeding the threshold duration, whether a group of unprocessed messages exists in the plurality of messages; and
returning, in response to the existence of the group of unprocessed messages in the plurality of messages, the group of unprocessed messages to the message queue.

2. The method of claim 1, wherein comparing the accumulated duration for processing the plurality of messages with the threshold duration comprises:
timing, in response to the plurality of messages being fetched, the processing of the plurality of messages to determine the accumulated duration; and
comparing, in response to the message among the plurality of messages having been processed, the accumulated duration with the threshold duration.

3. The method of claim 1, wherein determining whether there is the group of unprocessed messages in the plurality of messages comprises:
determining a first number of processed messages in the plurality of messages; and
determining, in response to the first number being less than a second number of the plurality of messages, that the group of unprocessed messages exists in the plurality of messages.

4. The method of claim 1, further comprising:
determining, in response to the accumulated duration not exceeding the threshold duration, whether the group of unprocessed messages exists in the plurality of messages; and
processing, in response to there being the group of unprocessed messages in the plurality of messages, the group of unprocessed messages.

5. The method of claim 1, wherein the plurality of messages are a first plurality of messages, and the method further comprises:
determining, in response to there being no group of unprocessed messages in the plurality of messages, that the first plurality of messages have been processed; and
waiting for a predetermined duration to fetch, from the message queue, a second plurality of messages for processing.

6. The method of claim 1, wherein returning the group of unprocessed messages to the message queue comprises:
acquiring the group of unprocessed messages; and
adding the group of unprocessed messages to a head of the message queue.

7. The method of claim 6, further comprising:
waiting for a predetermined duration;
fetching, from the message queue, a third plurality of messages for processing, the third plurality of messages comprising the group of unprocessed messages.

8. The method of claim 1, wherein the threshold duration is a refresh time interval for a user interface.

9. The method of claim 1, wherein the plurality of messages comprise three messages.

10. An electronic device, comprising:
at least one processor; and
a memory for storing at least one program, wherein the at least one program, when executed by the at least one processor, causes the at least one processor to:
fetch, from a message queue, a plurality of messages to be processed sequentially;
compare, in response to a message among the plurality of messages having been processed, an accumulated duration for processing the plurality of messages with a threshold duration;
determine, in response to the accumulated duration exceeding the threshold duration, whether a group of unprocessed messages exists in the plurality of messages; and
return, in response to the existence of the group of unprocessed messages in the plurality of messages, the group of unprocessed messages to the message queue.

11. The electronic device of claim 10, wherein the at least one program causing the at least one processor to compare the accumulated duration for processing the plurality of messages with the threshold duration comprises instructions to:
time, in response to the plurality of messages being fetched, the processing of the plurality of messages to determine the accumulated duration; and
compare, in response to the message among the plurality of messages having been processed, the accumulated duration with the threshold duration.

12. The electronic device of claim 10, wherein the at least one program causing the at least one processor to determine whether there is the group of unprocessed messages in the plurality of messages comprises instructions to:
determine a first number of processed messages in the plurality of messages; and
determine, in response to the first number being less than a second number of the plurality of messages, that the group of unprocessed messages exists in the plurality of messages.

13. The electronic device of claim 10, wherein the at least one program further comprises instructions to:
determine, in response to the accumulated duration not exceeding the threshold duration, whether the group of unprocessed messages exists in the plurality of messages; and
process, in response to there being the group of unprocessed messages in the plurality of messages, the group of unprocessed messages.

14. The electronic device of claim 10, wherein the plurality of messages are a first plurality of messages, the at least one program further comprises instructions to:
determine, in response to there being no group of unprocessed messages in the plurality of messages, that the first plurality of messages have been processed; and
wait for a predetermined duration to fetch, from the message queue, a second plurality of messages for processing.

15. The electronic device of claim 10, wherein the at least one program causing the at least one processor to return the group of unprocessed messages to the message queue comprises instructions to:
acquire the group of unprocessed messages; and
add the group of unprocessed messages to a head of the message queue.

16. The electronic device of claim 15, wherein the at least one program further comprises instructions to:
wait for a predetermined duration;
fetch, from the message queue, a third plurality of messages for processing, the third plurality of messages comprising the group of unprocessed messages.

17. The electronic device of claim 10, wherein the threshold duration is a refresh time interval for a user interface.

18. The electronic device of claim 10, wherein the plurality of messages comprise three messages.

19. A non-transitory computer-readable storage medium having a computer program stored thereon, wherein the computer program, when executed by a processor, causes the processor to:
fetch, from a message queue, a plurality of messages to be processed sequentially;
compare, in response to a message among the plurality of messages having been processed, an accumulated duration for processing the plurality of messages with a threshold duration;
determine, in response to the accumulated duration exceeding the threshold duration, whether a group of unprocessed messages exists in the plurality of messages; and
return, in response to the existence of the group of unprocessed messages in the plurality of messages, the group of unprocessed messages to the message queue.

20. The storage medium of claim 19, wherein the computer program causing the processor to compare the accumulated duration for processing the plurality of messages with the threshold duration comprises instructions to:
time, in response to the plurality of messages being fetched, the processing of the plurality of messages to determine the accumulated duration; and
compare, in response to the message among the plurality of messages having been processed, the accumulated duration with the threshold duration.
